(19) United States
(12) Patent Application Publication
(10) Pub. No.: US 2009/0215584 A1
(43) Pub. Date: Aug. 27, 2009

(54) HYDRAULIC CONTROL FOR A DUAL CLUTCH TRANSMISSION

(75) Inventors: Marco GRETHEL, BUEHLERTAL (DE); Manfred HOMM, BUEHL-NEUSATZ (DE); Eric MUELLER, KAISERSLAUTERN (DE); Martin STAUDINGER, ETTLINGEN (DE)

Correspondence Address: LUCAS & MERCANTI, LLP, 475 PARK AVENUE SOUTH, 15TH FLOOR, NEW YORK, NY, 10016, US

(73) Assignee: LuK Lamellen und Kupplungsbau Beteiligungs KG, Buehl (DE)

(21) Appl. No.: 12/436,994

(22) Filed: May 7, 2009

Related U.S. Application Data
(63) Continuation of application No. PCT/DE2007/001876, filed on Oct. 22, 2007.

(30) Foreign Application Priority Data
Nov. 8, 2006 (DE) 10 2006 052 642.2

(51) Int. Cl. F16H 61/688

(52) U.S. Cl. 477/79

(57) ABSTRACT

A dual clutch transmission which has a first clutch, actuated by a first hydraulic cylinder, a second clutch, actuated by a second hydraulic cylinder, shift devices for shifting gears, which are actuated by respective hydraulically operated cylinders, a hydraulic energy source for supplying the hydraulic cylinders and the hydraulically operated cylinders with hydraulic energy and a third clutch that is actuated by a third hydraulic cylinder.

The invention relates to a dual clutch transmission having a first clutch which is actuated by a first hydraulic cylinder, a second clutch which is actuated by a second hydraulic cylinder, a plurality of shifting apparatuses for shifting gears which are actuated in each case by a hydraulically acting cylinder, and having a hydraulic energy source for supplying the hydraulic cylinders and the hydraulically acting cylinders with hydraulic energy.

It is known to shift standard transmissions, in particular dual clutch transmissions, hydraulically and to actuate the two clutches hydraulically.

It is an object of the invention to provide an advanced dual clutch transmission which is adapted, in particular, to the requirements of advanced drive technologies.

The object is achieved by way of a dual clutch transmission, having a first clutch which is actuated by a first hydraulic cylinder, a second clutch which is actuated by a second hydraulic cylinder, a plurality of shifting apparatuses for shifting gears which are each actuated by a hydraulically acting cylinder, and having a hydraulic energy source for supplying the hydraulic cylinders and the hydraulically acting cylinders with hydraulic energy; in such a way that a third clutch is provided which is actuated by a third hydraulic cylinder. The third clutch can connect, for example, an electric motor to the conventional drive train of an internal combustion engine. It is therefore possible by means of the third clutch to realize a hybrid drive with the internal combustion engine and the electric motor. Moreover, it is conceivable to connect any other desired assembly, for example a second internal combustion engine, via the third clutch, or to disconnect it from the drive train.

Moreover, the object is achieved by way of a dual clutch transmission, having a first clutch which is actuated by a first hydraulic cylinder, a second clutch which is actuated by a second hydraulic cylinder, a plurality of shifting apparatuses for shifting gears which are actuated in each case by a hydraulically acting cylinder, and having a hydraulic energy source for supplying the hydraulic cylinders and the hydraulically acting cylinders with hydraulic energy; in such a way that, in order to cool the first, second and/or third clutch, a cooling oil unit is provided with an oil cooler for cooling cooling oil and with a conveying device for supplying the clutch/clutches with the cooling oil. The cooling unit can be, for example, a separate assembly which is completely independent of the hydraulic system of the other dual clutch transmission. One or more of the clutches can advantageously be cooled with cooling oil via the cooling oil unit, which has an advantageous effect on the wear and the maximum torque which can be transmitted. Furthermore, it is conceivable to dispense with the separate cooling oil unit, for example by simply omitting the separate cooling oil unit. A variant can easily be produced in this way, for example for the case where different motorizations are combined with the same dual clutch transmission: it is therefore conceivable not to provide any cooling by omission of the cooling oil unit, for example for a less powerful motorization, since the lower moments can also be transmitted by drier clutches.

Moreover, the object is achieved by way of a dual clutch transmission, having a first clutch which is actuated by a first hydraulic cylinder, a second clutch which is actuated by a second hydraulic cylinder, a plurality of shifting apparatuses for shifting gears which are actuated in each case by a hydraulically acting cylinder, and having a hydraulic energy source for supplying the hydraulic cylinders and the hydraulically acting cylinders with hydraulic energy; in such a way that a total of five shifting apparatuses are provided. The shifting apparatuses are coupled to the corresponding hydraulically acting cylinders and serve to engage the different gears of the dual clutch transmission. To this end, the shifting apparatuses can have selector forks which are coupled to the hydraulically acting cylinders and are in turn assigned to corresponding selector rods of the dual clutch transmission. Any desired number of gears can advantageously be shifted, for example up to ten gears or more.

Moreover, the object is achieved by way of a dual clutch transmission, having a first clutch which is actuated by a first hydraulic cylinder, a second clutch which is actuated by a second hydraulic cylinder, a plurality of shifting apparatuses for shifting gears which are each actuated by a hydraulically acting cylinder, and having a hydraulic energy source for supplying the hydraulic cylinders and the hydraulically acting cylinders with hydraulic energy; in such a way that the hydraulic energy source has a pump and an electric drive which drives the pump. The hydraulic energy source is therefore independent of the internal combustion engine which is shifted by the dual clutch transmission. The hydraulic energy source can therefore supply the dual clutch transmission with hydraulic energy even when the internal combustion engine is switched off. This can be utilized advantageously, for example, to realize a start/stop function.

Preferred exemplary embodiments are distinguished by the fact that a safety valve is provided which, in a safety position, disconnects the hydraulic energy source and switches to pressureless the first and second hydraulic cylinders, pressure reducing valve units which are provided for controlling the hydraulic cylinders, and a control valve arrangement which is provided for controlling the hydraulically acting cylinders, in particular connects them to a tank. Depending on the design of the dual clutch transmission, it is possible that it locks as a result of an impermissible shifting combination of the shifting apparatuses. As a result of the safety valve being moved into the safety switching position, it is possible to switch all essential actuators of the dual clutch transmission to pressureless, with the result that, at least in the case of an undesirable switching position of this type occurring in a manner which is possibly caused by a fault, further damage can be prevented by the corresponding actuators being switched to pressureless. For example, switching the corresponding hydraulic cylinders of the first and second clutches to pressureless leads to immediate disengagement, with the result that, for example, wheels which are connected behind them freewheel.

Further preferred exemplary embodiments are distinguished by the fact that the hydraulic cylinders and the hydraulically acting cylinders have displacement sensors for detecting the current cylinder position. Said displacement sensors can advantageously generate information which is necessary for controlling and regulating the dual clutch transmission. Moreover, it is possible to dispense with otherwise necessary more expensive pressure sensors as a result.

Further preferred exemplary embodiments are distinguished by the fact that a pressure accumulator is connected downstream of the hydraulic energy source. As a result, the hydraulic energy source can advantageously be used in interval operation. As a result, valuable electrical energy can be saved, in particular. Furthermore, it is possible to reduce brief pressure fluctuations of the hydraulic system by means of the pressure accumulator, in particular in the hydraulic system of the dual clutch transmission which is connected downstream of the hydraulic energy source. Pulses which possibly occur and are caused by the hydraulic energy source can advantageously be damped by the pressure accumulator.

Further preferred exemplary embodiments are distinguished by the fact that a first pressure reducing valve unit is provided for controlling the first hydraulic cylinder hydraulically, a second pressure reducing valve unit is provided for controlling the second hydraulic cylinder, and a third pressure reducing valve unit is provided for controlling the third hydraulic cylinder. The corresponding hydraulic cylinders of the clutches can each be supplied with hydraulic energy via the pressure reducing valve units, separately and in a metered manner. Gentle engagement or disengagement of the clutches can therefore be controlled via the pressure reducing valve units.

Further preferred exemplary embodiments are distinguished by the fact that one electrically actuable proportional magnet is provided for actuating each of the pressure reducing valve units. The hydraulics of the clutches can therefore be controlled and/or regulated electrically.

Further preferred exemplary embodiments are distinguished by the fact that a control valve arrangement is provided for actuating the hydraulically acting cylinders hydraulically. The control valve arrangement assumes the complete hydraulic control of the hydraulically acting cylinders. Any desired gear of the dual clutch transmission can therefore be set or selected by corresponding setting of the control valve arrangement. To this end, the control valve arrangement can have, for example, a multiplicity of hydraulic slide valves. Moreover, the control valve arrangement can have a rotary slide valve.

Further advantages, features and details result from the following description, in which one exemplary embodiment is described in detail with reference to the drawing, in which:

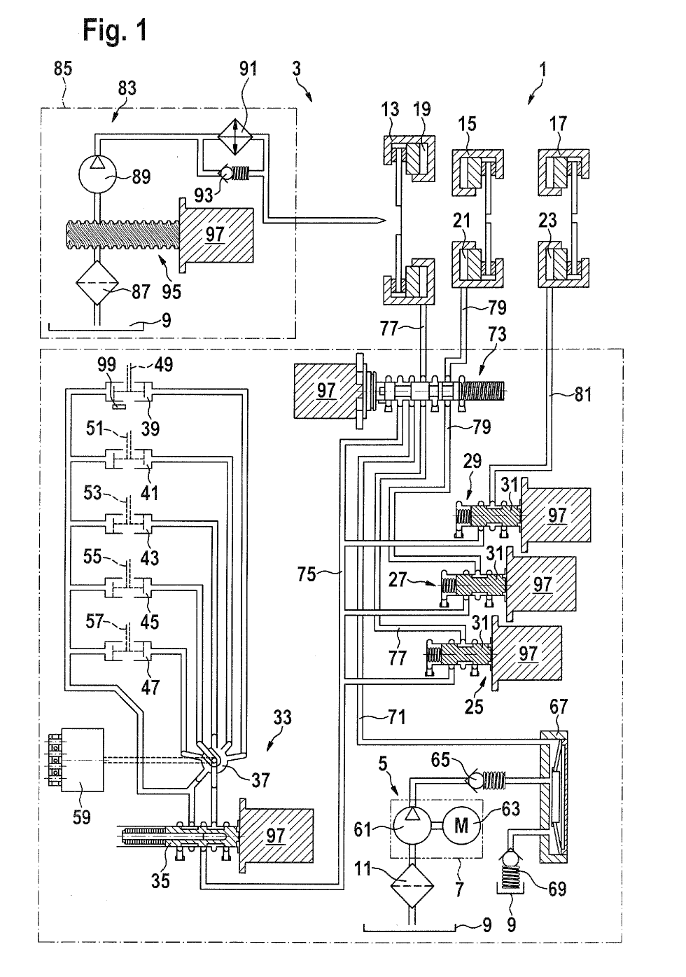

FIG. 1 shows a hydraulic diagram of a hydraulic system for controlling a dual clutch transmission.

FIG. 1 schematically shows the hydraulic circuit diagram of a dual clutch transmission 1 or a hydraulic system 3 for actuating the dual clutch transmission 1 hydraulically.

The hydraulic system 3 of the dual clutch transmission 1 has a hydraulic energy source 5. The hydraulic energy source 5 is indicated by means of a dash dotted line 7 and serves to supply the hydraulic system 3, which is connected downstream thereof, with hydraulic energy. The hydraulic energy source 5 is fed in a known manner with a suitable hydraulic medium from a tank 9. One or more suction filters 11 can be connected between the tank 9 and the hydraulic energy source 5 for cleaning the hydraulic medium.

The dual clutch transmission 1 has a first clutch 13, a second clutch 15 and a third clutch 17. The clutches 13 to 17 can be actuated by means of the hydraulic system 3. To this end, the first clutch 13 has a first hydraulic cylinder 19, the second clutch 15 has a second hydraulic cylinder 21 and the third clutch 17 has a third hydraulic cylinder 23, which hydraulic cylinders 19, 21, 23 can each be actuated via a first pressure reducing valve unit 25, a second pressure reducing valve unit 27 and a third pressure reducing valve unit 29 of the hydraulic system 3.

The pressure reducing valve units 25 to 29 each have one actuating piston 31, a linear displacement of the actuating piston 31 causing a direct proportional supply of hydraulic energy which is delivered from the hydraulic energy source 5 to the corresponding hydraulic cylinders 19 to 23 of the clutches 13 to 17 which are connected downstream thereof. The clutches 13 to 17 are designed in such a way that an increase in the pressure in the corresponding hydraulic cylinders 19 to 23 closes the respective clutch 13 to 17. The clutches 13 to 17 are therefore open in the pressureless state. However, a reversed design is also possible, in which at least one or all the clutches 13 to 17 is/are closed in the pressureless state.

In order to set the gears of the dual clutch transmission 1, the hydraulic system 3 has a control valve arrangement 33. The control valve arrangement 33 is likewise supplied with hydraulic energy by means of the hydraulic energy source 5 and serves to control hydraulically acting cylinders of the dual clutch transmission 1.

In FIG. 1, the control valve arrangement has a reversal valve 35 and a rotary slide valve 37 which is connected downstream of said reversal valve 35. The rotary slide valve 37 is assigned a first hydraulically acting cylinder 39, a second hydraulically acting cylinder 41, a third hydraulically acting cylinder 43, a fourth hydraulically acting cylinder 45 and a fifth hydraulically acting cylinder 47. The first hydraulically acting cylinder 39 controls a first shifting apparatus 49, for example designed for engaging the reverse gear. The second hydraulically acting cylinder 41 controls a second shifting apparatus 51, for example for engaging the first or third gear of the dual clutch transmission 1. The third hydraulically acting cylinder 43 controls a third shifting apparatus 53, for example designed for engaging the second or fourth gear of the dual clutch transmission 1. The fourth hydraulically acting cylinder 45 controls a fourth shifting apparatus 55, for example designed for engaging the fifth or seventh gear. The fifth hydraulically acting cylinder 47 controls a fifth shifting apparatus 57, for example designed for engaging the sixth or eighth gear of the dual clutch transmission 1.

To this end, the hydraulically acting cylinders 39 to 47 are each of dual action design, that is to say have two faces which lie opposite one another and can be loaded with pressure. It is also possible to control the selector rods by way of individual hydraulically acting cylinders which act correspondingly in opposite directions. The rotary slide valve 37 can be moved by means of a stepping motor 59 into a total of five different switching positions. In addition, the rotary slide valve 37 can have a neutral position. Here, in each of the switching positions, only one of the hydraulically acting cylinders 39 to 47 (in the orientation of FIG. 1) is connected on the right hand side to an output of the reversal valve 35. On the left hand side, independently of the switching position of the rotary slide valve 37, all the hydraulically acting cylinders 39 to 47 are assigned to a further output of the reversal valve.

FIG. 1 shows the rotary slide valve 37 in a fourth switching position, the fourth shifting apparatus 55 or the fourth hydraulically acting cylinder 45 associated with it is connected hydraulically to the reversal valve 35 in such a way that the fourth hydraulically acting cylinder 45, as viewed in the orientation of FIG. 1, can be loaded with pressure either coming from the left or coming from the right and can be connected to the tank 9 on the opposite side, respectively. As a result, the fifth or the seventh gear of the dual clutch transmission 1 can therefore be engaged depending on the switching position of the reversal valve 35. The remaining hydraulically acting cylinders 39, 41, 43, 47 are jammed on the right hand side on account of the rotary slide valve 37 which is closed for them. Depending on the switching position of the reversal valve 35, said remaining hydraulically acting cylinders 39, 41, 43, 47 are jammed either at a high pressure level, for example approximately system pressure, or at a low pressure level, for example approximately tank pressure. It can therefore also be ensured that a gear which has already been engaged does not jump out again accidentally, for example in the event of particularly unfavorable driving states.

Moreover, the reversal valve 35 can be moved into a switching position which is shown in FIG. 1, the complete fourth hydraulic cylinder 45 being switched to pressureless, that is to say being connected to the tank 9.

The remaining gears are shifted analogously according to the switching positions of the reversal valve 35 and the rotary slide valve 37 which is connected downstream thereof. In order to change the transmission ratio, the corresponding gears of a desired gear pair can thus be engaged one after another.

In order to shift more or fewer gears, as many selector rods and associated hydraulically acting cylinders as desired can be provided additionally for actuation or can be omitted. The control valve arrangement 33 can likewise be modified correspondingly to this end or can have the corresponding shifting possibilities added to it or taken away.

The hydraulic energy source 5 has a pump 61, designed for conveying the hydraulic medium. The pump 61 is driven by means of a coupled electric drive 63, for example an electric motor. A first nonreturn valve 65 which prevents the hydraulic medium from flowing back, for example when the pump 61 is switched off, is connected downstream of pump 61. A pressure accumulator 67 is connected downstream of the first nonreturn valve 65. The pressure accumulator 67 serves to store hydraulic medium at a desired working pressure. In order to prevent this working pressure from rising above a maximum value which could possibly also lead to destruction of the pressure accumulator 67, the pressure accumulator 67 is coupled downstream to a second nonreturn valve 69. The second nonreturn valve 69 is connected as a pressure relief valve and opens, when a pressure limit is exceeded, toward the tank 9. Upstream, the pressure accumulator 67 feeds a pressure accumulator line 71 with the hydraulic medium. A safety valve block 73 is connected behind the pressure accumulator line 71. The safety valve block 73 serves, in the case of a potentially occurring fault that could lead, in particular, to blocking of the dual clutch transmission 1, to separate all the actuating elements, that is to say, for example, the reversal valve 35 and the first to third pressure reducing valve units 25 to 29, from the hydraulic energy source 5 and/or to switch them to pressureless. To this end, the pressure accumulator line 71 can be separated from the hydraulic energy source 5 by means of the safety valve block 73. In one operating position of the safety valve block 73, a feed line 75 can be supplied with hydraulic energy, that is to say can be connected to the pressure accumulator line 71. The feed line 75 supplies the pressure reducing valve units 25 to 29 and the reversal valve 35 with hydraulic medium. Moreover, in this operating position of the safety valve block 73, the first and second clutches 13 and 15 can be controlled hydraulically by means of the first and second pressure reducing valve units 25 and 27.

Moreover, in the safety position of the safety valve block 73, the feed line 75 and the first and second hydraulic cylinders 19 and 21 can be switched to pressureless, that is to say can be connected to the tank 9.

The first pressure reducing valve unit 25 is connected behind the first hydraulic cylinder 19 of the first clutch 13 via a first control line 77. In order to control the first clutch 13, the first hydraulic cylinder 19 can be loaded with hydraulic medium through the safety valve block 73 as a result of a corresponding actuating movement of the actuating piston 31 of the first pressure reducing valve unit 25. The second clutch 15 is controlled analogously, to which end the hydraulic system 3 has a second control line 79 which is connected behind the second pressure reducing valve unit 27. The third clutch 17 is likewise controlled via a third control line 81 which is connected behind the third pressure reducing valve unit 29. In contrast, the third control line 81 cannot be emptied via the safety valve block 73, that is to say be connected directly to the third hydraulic cylinder 23 of the third clutch 17. The third clutch 17 can be a hybrid clutch for coupling a further assembly, for example an electric motor. This assembly is therefore not connected via the dual clutch transmission 1 and therefore, in the case of a fault of the dual clutch transmission 1, also does not have to be emptied as quickly as possible via the safety valve block 73. However, it is also possible to switch the third clutch 17 analogously to the remaining clutches 13 and 15.

At least one of the clutches 13 to 17 can be coupled to a separate cooling oil unit 83 in order to reduce the wear and to maximize the torque which can be transmitted. The cooling oil unit 83 is indicated by a dashed line 85 and has a suction filter 87, a pump 89 connected downstream thereof, and an oil cooler 91. A third nonreturn valve 93 which opens at a comparatively high back pressure in the oil cooler 91 is connected parallel to the oil cooler 91. This can advantageously be utilized to regulate the temperature of the cooling oil, a higher back pressure occurring in the oil cooler in the case of comparatively cool cooling oil, that is to say in the case of a comparatively high viscosity. In this case, the third nonreturn valve 93 opens, with the result that the oil cooler 91 can be bypassed. This advantageously leads to hydraulic energy being saved. Moreover, the cooling oil flow can be controlled by means of a control element 95 which acts on the cooling oil flow. The suction filter 87 and the pump 89 can likewise be fed via the tank 9. However, it is also conceivable to design the cooling oil unit as a completely separate unit, that is to say with a separate coolant circuit and as a consequence with a dedicated tank.

The hydraulic system 3 (shown in FIG. 1) of the dual clutch transmission 1 is controlled by means of electrically actuable magnets 97. In particular, the control element 95 of the cooling oil unit 83, the pressure reducing valve units 25 to 29, the reversal valve 35 and the safety valve block 73 can be controlled or switched via the magnets 97. Insofar as a proportional movement or force is required, the magnets 97 can be proportional magnets. Otherwise, they can be simple actuator magnets. The pressure reducing valve units 25 to 29 have, for example, magnets 97 of the type which are configured as proportional magnets. The hydraulic cylinders 19, 21, 23 and the hydraulically acting cylinders 39, 41, 43, 45, 47 can have displacement sensors 99 for detecting the current cylinder position. In FIG. 1, by way of example, a displacement sensor 99 is indicated on the hydraulic cylinder 39.

### LIST OF DESIGNATIONS

1. Dual clutch transmission
3. Hydraulic system
5. Hydraulic energy source
7. Line
9. Tank
11. Suction filter
13. First clutch
15. Second clutch
17. Third clutch
19. First hydraulic cylinder
21. Second hydraulic cylinder
23. Third hydraulic cylinder
25. First pressure reducing valve unit
27. Second pressure reducing valve unit
29. Third pressure reducing valve unit
31. Actuating piston
33. Control valve arrangement
35. Reversal valve
37. Rotary slide valve
39. First hydraulically acting cylinder
41. Second hydraulically acting cylinder
43. Third hydraulically acting cylinder
45. Fourth hydraulically acting cylinder
47. Fifth hydraulically acting cylinder
49. First shifting apparatus
51. Second shifting apparatus
53. Third shifting apparatus
55. Fourth shifting apparatus
57. Fifth shifting apparatus
59. Stepping motor
61. Pump
63. Electric drive
65. First nonreturn valve
67. Pressure accumulator
69. Second nonreturn valve
71. Pressure accumulator line
73. Safety valve block
75. Feed line
77. First control line
79. Second control line
81. Third control line
83. Cooling oil unit
85. Line
87. Suction filter
89. Pump
91. Oil cooler
93. Third nonreturn valve
95. Control element
97. Magnet
99. Displacement sensor

1. A dual clutch transmission, comprising: a first clutch which is actuated by a first hydraulic cylinder; a second clutch which is actuated by a second hydraulic cylinder; a plurality of shifting apparatuses for shifting gears which are actuated by hydraulically acting cylinders; and, a hydraulic energy source for supplying the first hydraulic cylinder, the second hydraulic cylinder and a third hydraulic cylinder and the hydraulically acting cylinders with hydraulic energy, wherein a third clutch is provided which is actuated by the third hydraulic cylinder.

2. The dual clutch transmission as claimed in claim 1, wherein, in order to cool the first clutch, the second clutch and/or the third clutch, a cooling oil unit has an oil cooler for cooling cooling oil and a conveying device for supplying the first clutch, the second clutch and/or the third clutch with the cooling oil.

3. The dual clutch transmission as claimed in claim 1, wherein five shifting apparatuses are provided.

4. The dual clutch transmission as claimed in claim 1, wherein the hydraulic energy source has a pump and an electric drive which drives the pump.

5. The dual clutch transmission as claimed in claim 1, wherein a safety valve block in a safety switching position, disconnects the hydraulic energy source and switches to pressureless the first hydraulic cylinder and the second hydraulic cylinder, pressure reducing valve units control the first hydraulic cylinder and the second hydraulic cylinder, and a control valve arrangement controls the hydraulically acting cylinders, connect the hydraulically acting cylinders to a tank.

6. The dual clutch transmission as claimed in claim 1, wherein the first hydraulic cylinder, the second hydraulic cylinder and the third hydraulic cylinder and the hydraulically acting cylinders have displacement sensors for detecting the current cylinder position.

7. The dual clutch transmission as claimed in claim 1, wherein a pressure accumulator is connected behind the hydraulic energy source.

8. The dual clutch transmission as claimed in claim 1, wherein a first pressure reducing valve unit controls the first hydraulic cylinder hydraulically, a second pressure reducing valve unit controls the second hydraulic cylinder, and a third pressure reducing valve unit controls the third hydraulic cylinder.

9. The dual clutch transmission as claimed in claim 8, wherein an electrically actuable proportional magnet controls the first pressure reducing valve unit, the second pressure reducing valve unit and the third pressure reducing valve unit.

10. The dual clutch transmission as claimed in claim 1, wherein a control valve arrangement actuates the shifting apparatuses hydraulically.

11. A hydraulic system for actuating a dual clutch transmission as claimed in claim 1, in particular having a combination of features as claimed in claim 1.
